(19) United States
(12) Patent Application Publication
(10) Pub. No.: US 2024/0267910 A1
(43) Pub. Date: Aug. 8, 2024

(54) PARTIAL UPLINK TRANSMISSION FOR SIMULTANEOUS TRANSMISSION ACROSS MULTIPLE PANELS

(71) Applicant: QUALCOMM Incorporated, San Diego, CA (US)

(72) Inventors: Diana MAAMARI, San Diego, CA (US); Ahmed ELSHAFIE, San Diego, CA (US); Mostafa KHOSHNEVISAN, San Diego, CA (US)

(21) Appl. No.: 18/164,397

(22) Filed: Feb. 3, 2023

(51) Int. Cl. H04W 72/1268; H04W 72/20

(52) U.S. Cl. CPC H04W 72/1268; H04W 72/20

(57) ABSTRACT

Certain aspects of the present disclosure provide techniques for partial uplink transmission and uplink skipping indication for uplink simultaneous transmissions across multiple panels. A method for wireless communications by a user equipment (UE), includes determining a resource allocation for an uplink simultaneous transmission of a first physical uplink shared channel (PUSCH) transmission and a second PUSCH transmission across multiple panels and transmitting control information indicating a subset of the resource allocation to be skipped by the UE for the uplink simultaneous transmission of the first PUSCH transmission and the second PUSCH transmission across the multiple panels.

### BACKGROUND

### Field of the Disclosure

Aspects of the present disclosure relate to wireless communications, and more particularly, to techniques for simultaneous transmission across multiple panels.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method may include determining a resource allocation for an uplink simultaneous transmission of a first physical uplink shared channel (PUSCH) transmission and a second PUSCH transmission across multiple panels. The method may include transmitting control information indicating a subset of the resource allocation to be skipped by the UE for the uplink simultaneous transmission of the first PUSCH transmission and the second PUSCH transmission across the multiple panels.

Another aspect provides a method for wireless communication by a network entity. The method may include outputting signaling to a UE with a resource allocation for an uplink simultaneous transmission of a first PUSCH transmission and a second PUSCH transmission across multiple panels. The method may include obtaining control information indicating a subset of the resource allocation to be skipped by the UE for the uplink simultaneous transmission of the first PUSCH transmission and the second PUSCH transmission across the multiple panels.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example base station and an example user equipment.

FIGS. 4A, 4B, 4C, and 4D depict various example aspects of data structures for a wireless communications network.

FIG. 5 depicts example partial uplink transmission with skipping.

FIG. 6A depicts simultaneous uplink transmission of a first PUSCH and a second PUSCH on resources fully-overlapping in time and fully-overlapping in frequency.

FIG. 6B depicts simultaneous uplink transmission of a first PUSCH and a second PUSCH on resources fully-overlapping in time and non-overlapping in frequency.

FIG. 6C depicts simultaneous uplink transmission of a first PUSCH and a second PUSCH on resources fully-overlapping in time and partially-overlapping in frequency.

FIG. 6D depicts simultaneous uplink transmission of a first PUSCH and a second PUSCH on resources partially-overlapping in time and non-overlapping in frequency.

FIG. 6E depicts simultaneous uplink transmission of a first PUSCH and a second PUSCH on resources partially-overlapping in time and partially-overlapping in frequency.

FIG. 6F depicts simultaneous uplink transmission of a first PUSCH and a second PUSCH on resources partially-overlapping in time and fully-overlapping in frequency.

FIG. 7 depicts a process flow for communications in a network between a UE and a network entity using a common uplink control information (UCI) indicating partial uplink transmission for uplink simultaneous transmission across multiple panels.

FIG. 8 depicts a process flow for communications in a network between a UE and a network entity using separate UCI indicating partial uplink transmission for uplink simultaneous transmission across multiple panels.

FIG. 9 depicts a method for wireless communications by a UE.

FIG. 10 depicts a method for wireless communications by a network entity.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for uplink simultaneous transmission across multiple panels (STxMP).

In some systems, a UE can receive an oversized allocation of resources. For example, the UE may be configured with, or indicated, more uplink resources than the UE needs, or desires, for an uplink transmission. When a UE has an oversized allocation of resources, the UE may perform partial uplink transmission, in which the UE uses only a portion of the allocated resources and “skips” (does not use for the uplink transmission) the other allocated resources. Partial uplink transmission may increase capacity, for example, by allowing the network to reuse the resources skipped by the UE for communications with a different UE. Alternatively, the UE can use all of the allocated resources for the uplink transmission, but changes a modulation and coding scheme (MCS) used for the uplink transmission to realize power savings gains.

In some systems, however, a UE may perform an uplink simultaneous transmission across multiple panels. In this case, the UE transmits multiple uplink transmissions, on overlapping time resources, using multiple antenna panels at the UE. The multiple uplink transmissions may have separate resource allocations. Aspects of the present disclose provide techniques for partial uplink transmission for such uplink simultaneous transmissions across multiple panels. The techniques provided herein may allow the system to extend the benefits of increased capacity and/or power savings gains realized by partial uplink transmission to the case of uplink simultaneous transmissions across multiple panels.

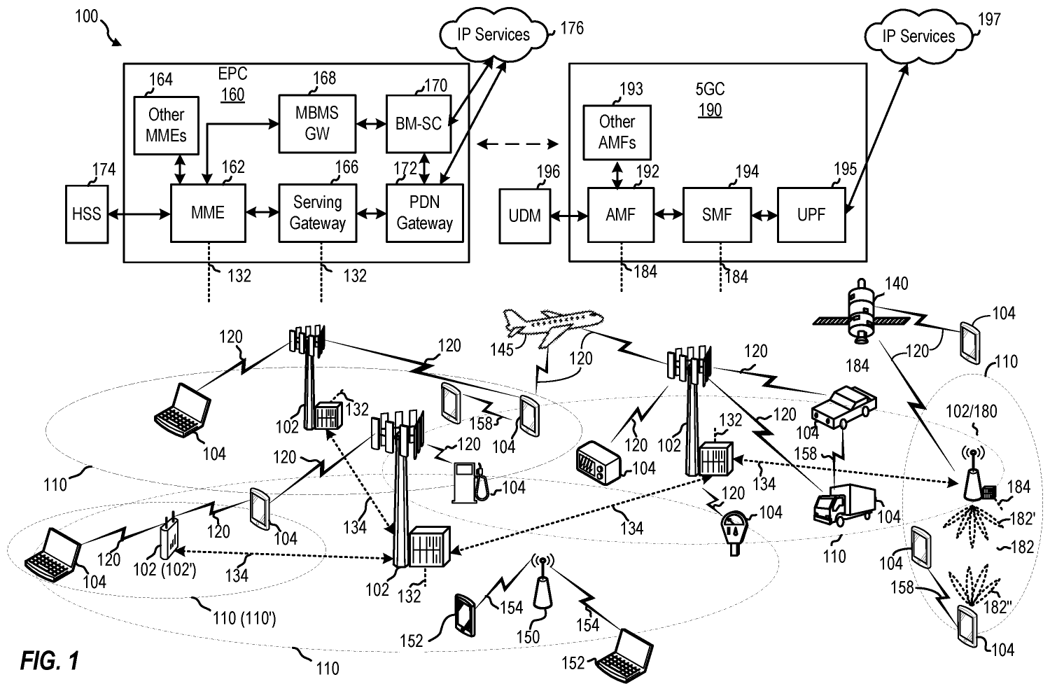

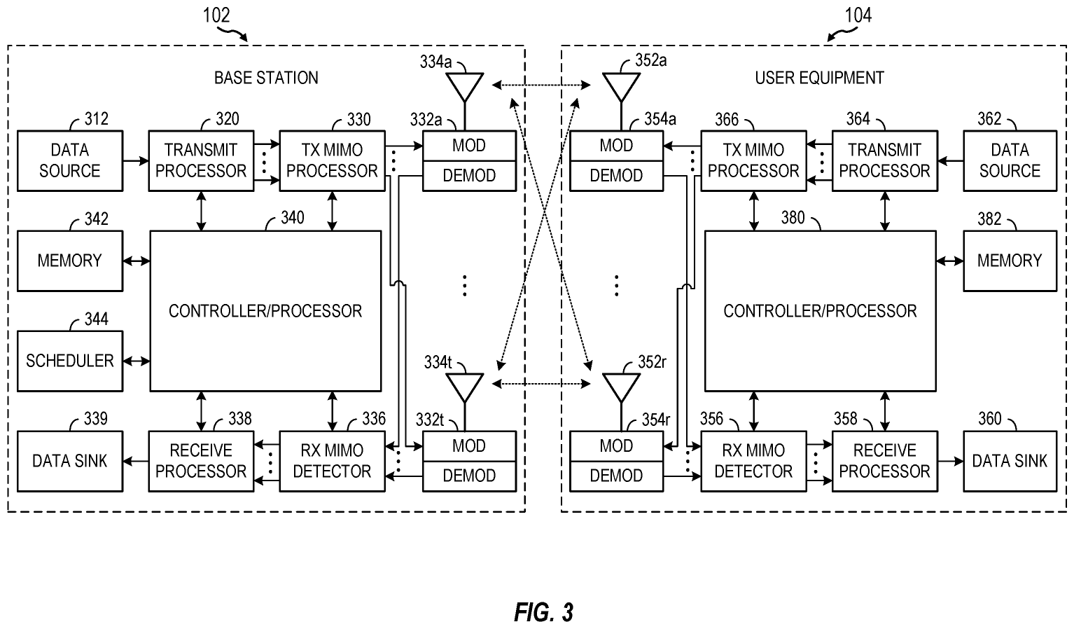

According to certain aspects, a UE (e.g., such as a UE 104 illustrated in FIG. 1 and FIG. 3) performs partial uplink transmission (e.g., with uplink skipping), of an uplink simultaneous transmission across multiple panels. In some aspects, the partial uplink transmission includes transmitting the uplink simultaneous transmission across multiple panels using only a subset of a resource allocation for the uplink simultaneous transmission across multiple panels, and skipping a remainder of the resource allocation. In some aspects, the partial uplink transmission includes transmitting using only a portion of time and/or frequency resource(s) and/or only a portion of configured transmission occasions configured (dynamically and/or semi-statically) for the uplink simultaneous transmission across multiple panels.

According to certain aspects, the UE provides control signaling to the network (e.g., such as a BS 102 illustrated in FIG. 1 and FIG. 3) indicating the partial uplink transmission. In some aspects, the control signaling indicates the portion of the allocated resources that are skipped for the uplink simultaneous transmission across multiple panels. In some aspects, the control signaling indicates the portion of the allocated resources that are used for the uplink simultaneous transmission across multiple panels.

In some aspects, the control signaling is provided by CG UCI, dynamic dedicated UCI, or dynamic MAC CE signaling. In some aspects, the control signaling is piggybacked on one or more PUSCHs of the uplink simultaneous transmission across multiple panels. In some aspects, the control signaling is provided in a separate PUCCH transmission.

In some aspects, the UE provides common control signaling for the uplink simultaneous transmission across multiple panels. In some aspects, the UE provides separate control signaling for the uplink simultaneous transmission across multiple panels.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

FIG. 1 depicts an example of a wireless communications network 100, in which aspects described herein may be implemented. As described in more detail herein, UEs 104 may perform partial uplink transmission for uplink simultaneous transmissions across multiple panels to BSs 102.

Generally, wireless communications network 100 includes various network entities (alternatively, network elements or network nodes). A network entity is generally a communications device and/or a communications function performed by a communications device (e.g., a UE, a BS, a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

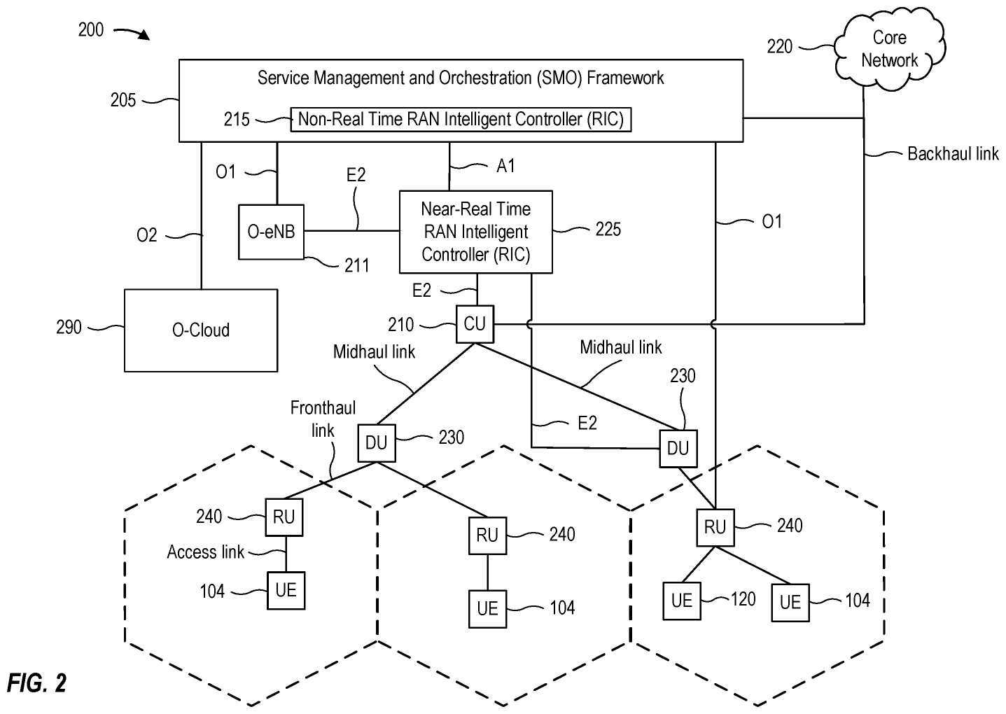

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as AI policies).

FIG. 3 depicts aspects of an example BS 102 and a UE 104. As described in more detail herein, one or more components of UE 104, depicted in FIG. 3, may be used to perform partial uplink transmission for uplink simultaneous transmissions across multiple panels to one or more components of BS 102 depicted in FIG. 3.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by ULE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

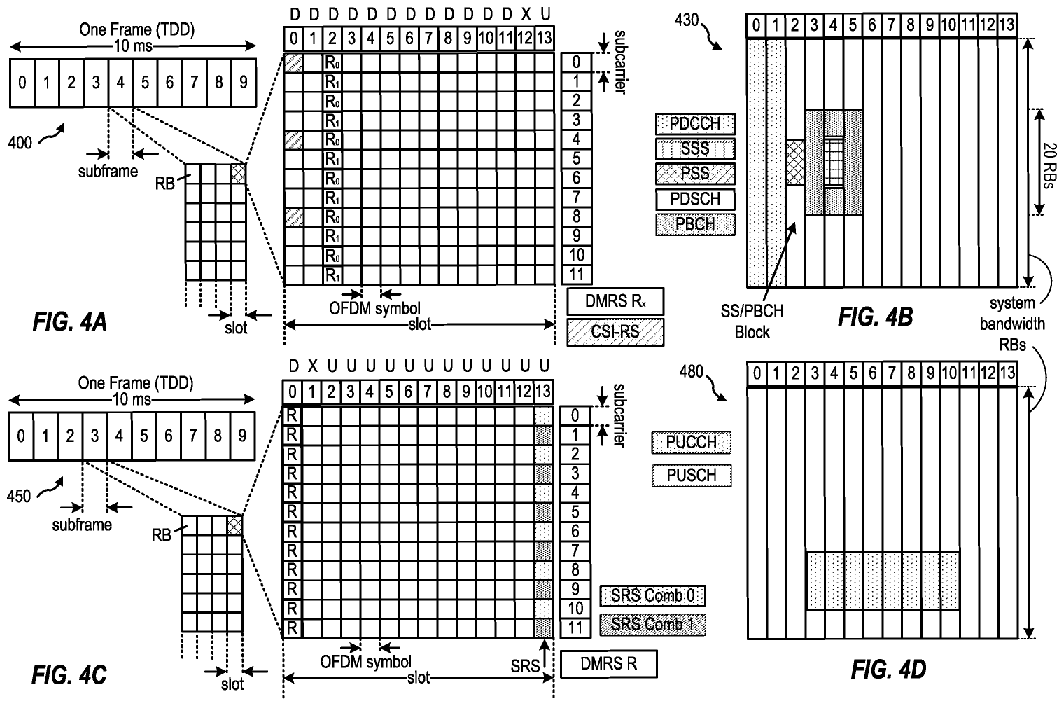

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5GNNR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 21×15 kHz, where is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Resource Allocations

Radio resources can be allocated to a UE by configured scheduling, dynamic scheduling, or a combination of configured and dynamic scheduling.

Configured scheduling is a mechanism in which the network can schedule PUSCH resources for the UE without using DCI to schedule each PUSCH transmission. Configured scheduling is done by configuring the UE with the scheduling parameters semi-statically in RRC signaling. Configured scheduling helps reduce the scheduling overhead.

Configured scheduling for the uplink may be done using a configured grant (CG). Two different types of configured grants include Type 1 CGs and Type 2 CGs. In Type 1 CG, the network send higher layer RRC signaling (e.g., an RRCSetup or RRCReconfiguration message according to 3GPP TS 38.331) configuring all the parameters for PUSCH scheduling including a resource allocation. The UE may transmit PUSCH according to configured scheduling, without receiving any lower layer trigger (e.g., DCI). In Type 2 CG, after the RRC configuration, the network sends a DCI (e.g., masked with a configured scheduling radio network temporary identifier (CS-RNTI)) to activate the configured grant. In both Type 1 CG and Type 2 CG, the network may send MAC CE signaling to downselect the RRC configured resources and/or DCI overwriting the configured scheduling. Because the configured scheduling is semi-static, the UE may be overallocated with resources for uplink transmission, for example, due to changed channel conditions.

For dynamic grants, the network may send DCI to schedule each uplink transmission for the UE. In some cases, the network schedules uplink resources for the UE based on buffer status reports (BSRs) received from the UE. However, if a BSR accurately reflecting the UEs buffer size is not recently received, the network may still overallocate resources for the UE. In addition, a BSR codepoint can correspond to a large range (e.g., 7-8 MB). In addition, a UE may first send a scheduling request (SR) for resources to send the BSR. SR and BSR transmission, and waiting for an uplink grant, may increase uplink latency at the UE.

### Aspects Related to Partial Uplink Transmission

In some cases (e.g., in NR Release-15 and Rel-16 systems), such as when the UE is overallocated with resources for uplink transmission, the UE may perform partial uplink transmission. Partial uplink transmission allows a UE to skip (e.g., ignore, refrain from utilizing for transmission) allocated (whether dynamically or semi-statically configured) resources. Partial uplink transmission may also be referred to as uplink skipping.

In some aspects, skipping is configured at the UE (e.g., when an enhancedSkipUplinkTxDynamic or skipUplinkTxDynamic RRC parameter is set to true as described in 3GPP TS 38.822). In some cases, before the network configures flexible uplink transmission skipping, the network may confirm the UE supports such skipping. For example, a UE capability may be defined that indicates support of flexible UL skipping configuration. The UE capability may be exchanged after the UE has established an RRC connected mode with the network. In some cases, the capability may be separate for flexible skipping of UL resources associated with dynamic grants and configured grants. For example, the signaling for support of skipping for dynamic grants and configured grants may be different.

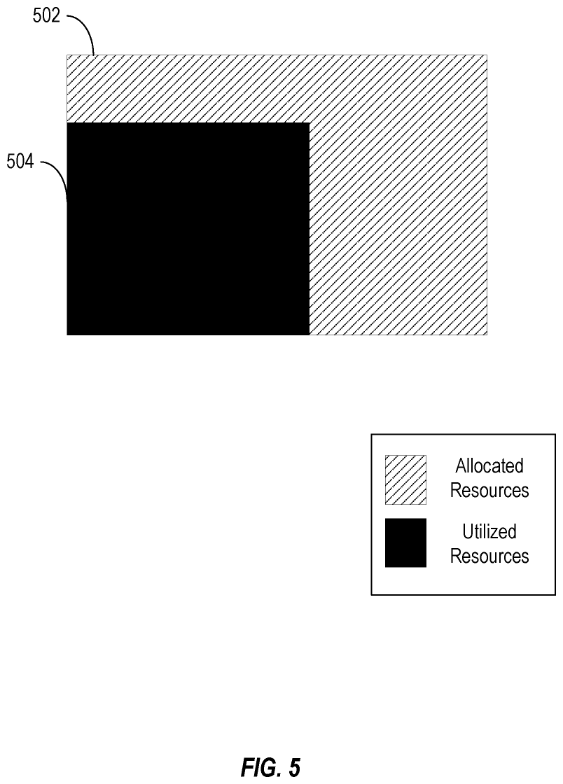

If skipping is configured at the UE and if the UE does not have sufficient data (e.g., a new MAC protocol data unit (PDU)) to transmit in the allocated uplink resources, or does not need all of the allocated uplink resource to transmit the data, the UE may skip all or a portion of the allocated resources. As shown in FIG. 5, for example, a UE with allocated resources 502 (e.g., 50 available UL RBs in a 20 MHz system with a 30 kHz SCS) may transmit utilizing only a portion 504 of the allocated resource 502 (e.g., with a transport block size (TBS) for PUSCH requiring only 10 RBs). Alternatively, the UE can use all of the allocated resources for the uplink transmission, and adjust the MCS of the uplink transmission.

In some examples, rather than signal a precise set of RBs, a network entity may signal multiple sets of RBs that a UE may transmit on. The UE may pick one set to transmit on, while the BS may perform a search over each of the configured sets to identify the set of RBs the UE transmitted on.

In some examples, the network entity may signal a range of RBs over which the UE can transmit. The UE may select the particular number and set of RBs to use for transmission. For example, the particular number or set of RBs that the UE selects may be based on channel estimation or the number of information bits available. The UE may select a set of RBs that optimize UL throughput. For example, the UE may estimate the downlink channel and, based on channel reciprocity, estimate the uplink channel. The UE may select RBs that have favorable channel gain conditions. In some examples, a table may be defined (e.g., in a standard specification) that includes the TBS and the RBs allocation used.

### Aspects Related to Uplink Simultaneous Transmission Across Multiple Panels

In some systems (e.g., NR Rel-18 systems) a UE can transmit simultaneously using multiple panels at the UE. Such transmission may be referred to a multiple transmission reception point (mTRP) or STxMP. For example, the UE can simultaneously transmit two different PUSCHs in the same serving cell (e.g., in the same component carrier (CC)) on by using different panels at the UE.

The PUSCHs may be associated with different control resource set (CORESET) pool index values, different SRS resource sets, different beams, different transmission configuration indicator (TCI) states, different power control parameters, and/or different precoders. In some examples, one or more CORESETS are configured by RRC signaling (e.g., a ControlResourceSet IE as discussed in 3GPP TS 38.331). The CORESET includes time and frequency resources in which to search for DCI. A set of one or more CORESETs may be associated with a CORESET pool identified by a CORESET pool index value (e.g., configured in the RRC signaling via a coresetPoolIndex parameter). For example, two CORESET pools may be configured with the CORESET pool index values 0 and 1, respectively. In some examples, the CORESET pool index value associated with a transmission may be used to determine a default quasi-colocation (QCL) assumption for the transmission.

This simultaneous transmission of two different PUSCHs is different than a spatial division multiplexing (SDM) and/or frequency division multiplexing (FDM) transmission within a single PUSCH.

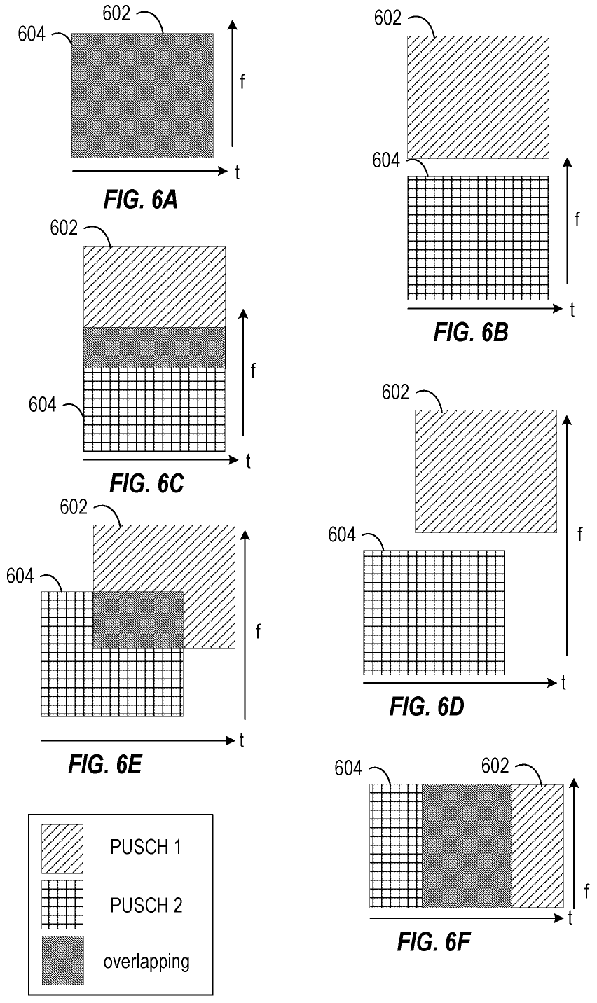

In the time domain, the PUSCH are either partially-overlapping or fully-overlapping time domain resources. In the frequency domain, the PUSCHs may be non-overlapping, partially-overlapping, or fully-overlapping. FIG. 6A depicts simultaneous uplink transmission of a PUSCH 602 (PUSCH 1) and a PUSCH 604 (PUSCH 2) on resources fully-overlapping in time and fully-overlapping in frequency. FIG. 6B depicts example simultaneous uplink transmission of PUSCH 602 and PUSCH 604 on resources fully-overlapping in time and non-overlapping in frequency. FIG. 6C depicts simultaneous uplink transmission of PUSCH 602 and PUSCH 604 on resources fully-overlapping in time and partially-overlapping in frequency. FIG. 6D depicts example simultaneous uplink transmission of PUSCH 602 and PUSCH 604 on resources partially-overlapping in time and non-overlapping in frequency. FIG. 6E depicts example simultaneous uplink transmission of PUSCH 602 and PUSCH 604 on resources partially-overlapping in time and partially-overlapping in frequency. FIG. 6F depicts example simultaneous uplink transmission of PUSCH 602 and PUSCH 604 on resources partially-overlapping in time and fully-overlapping in frequency.

The PUSCHs for an uplink simultaneous transmission across multiple panels can be configured by a single DCI, separate DCIs (e.g., DG-PUSCH+DG-PUSCH), a CG, separate CGs (e.g., CG-PUSCH+CG-PUSCH), or a combination of DCI and CG (e.g., DG-PUSCH+CG-PUSCH). Currently, partial uplink transmission is designed for the case of a resource allocation for single PUSCH. Accordingly, techniques are needed for partial uplink transmission for uplink simultaneous transmission across multiple panels.

### Aspects Related to Partial Uplink Transmission for Simultaneous Transmission Across Multiple Panels

According to certain aspects, a UE (e.g., such as a UE 104 illustrated in FIG. 1 and FIG. 3) performs partial uplink transmission (e.g., with uplink skipping), of an uplink simultaneous transmission across multiple panels and the UE provides control signaling to the network (e.g., such as a BS 102 illustrated in FIG. 1 and FIG. 3) indicating the partial uplink transmission.

In some aspects, the partial uplink transmission includes transmitting the uplink simultaneous transmission across multiple panels using only a subset of a resource allocation for the uplink simultaneous transmission across multiple panels, and skipping a remainder of the resource allocation. In some aspects, the partial uplink transmission includes transmitting using only a portion of time and/or frequency resource(s) and/or only a portion of configured transmission occasions configured (dynamically and/or semi-statically) for the uplink simultaneous transmission across multiple panels.

In some aspects, the control signaling indicates the portion of the allocated resources that are skipped for the uplink simultaneous transmission across multiple panels. In some aspects, the control signaling indicates the portion of the allocated resources that are used for the uplink simultaneous transmission across multiple panels. In some aspects, the control signaling is provided by CG UCI, dynamic dedicated UCI, and/or dynamic MAC CE signaling.

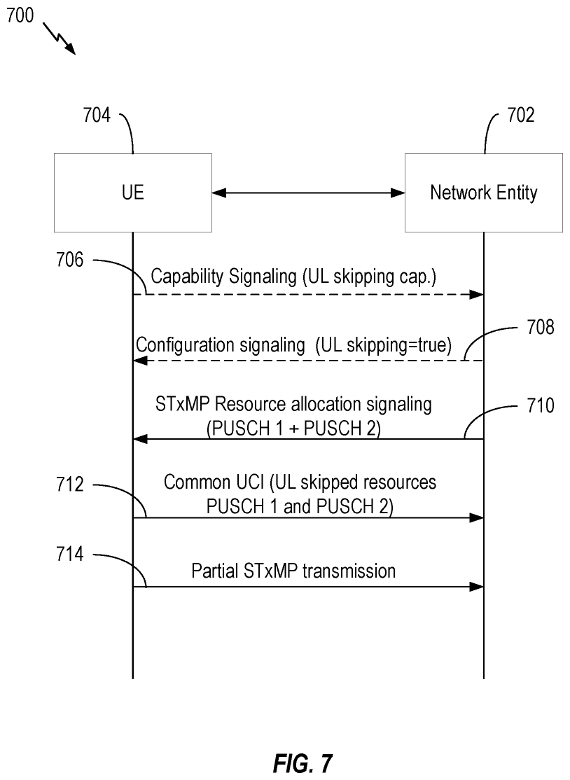

In some aspects, the UE provides common control signaling for the uplink simultaneous transmission across multiple panels. FIG. 7 depicts a process flow 700 for communications in a network between a UE 704 and a network entity 702 using a common UCI indicating partial uplink transmission for uplink simultaneous transmission across multiple panels. In some aspects, the network entity 702 may be an example of the BS 102 depicted and described with respect to FIGS. 1 and 3 or a disaggregated BS depicted and described with respect to FIG. 2. Similarly, the UE 704 may be an example of UE 104 depicted and described with respect to FIGS. 1 and 3. However, in other aspects, UE 104 may be another type of wireless communications device and BS 102 may be another type of network entity or network node, such as those described herein.

At operation 706, optionally, UE 704 may provide capability signaling to network entity 702 indicating one or more capabilities of the UE 704. In some aspects, UE 704 indicates the UE 704 support uplink skipping capability in the capability signaling at operation 706.

At operation 708, optionally, network entity 702 may provide configuration signaling to UE 704 configuring one or more parameters at the UE 704. In some aspects, network entity 702 configures the UE 704 for uplink skipping in the configuration signaling at operation 706. In some aspects, the configuration signaling is RRC signaling.

At operation 710, network entity 702 configures UE 704 with a resource allocation for uplink simultaneous transmission across multiple panels. As described herein, the resource allocation may be for a first PUSCH and a second PUSCH transmission and may be provided by configured grant(s), dynamic grant(s), or a combination of CG and DG. It should be understood that although shown a single operation 710, the resource allocation may be provided in multiple operations and in separate signaling.

At operation 712, UE 704 provides control signaling to network entity 702 indicating the uplink skipping. In some aspects, UE 704 providing a common UCI indicating the UL skipping for uplink simultaneous transmission across multiple panels, as shown in FIG. 7. For example, the common UCI at operation 712 indicates uplink skipped resources for the PUSCH 1 and PUSCH 2 of the uplink simultaneous transmission across multiple panels. In some aspects, network entity 702 communicates over a backhaul with another network entity (not shown). In some examples, the network entity 702 and the other network entity coordinate reception of the uplink simultaneous transmission across multiple panels.

In some aspects, the resource allocation signaling at operation 710 includes a dynamic grant DCI that activates or schedules PUCCH resources for the common UCI used to indicate the uplink skipping information. In some aspects, the resource allocation signaling at operation 710 includes a configured grant and a DCI that activates the configured grant. In some examples, the activation DCI activates or schedules the PUCCH resources for the common UCI used to indicate the uplink skipping information. In some aspects, the common UCI includes an indication of an offset, k, from the PUSCH at which the PUCCH carrying the UCI may be transmitted. In some examples, a dynamic grant DCI activates or schedules PUCCH resource for the separate UCI associated with a DG-PUSCH and an activation DCI activates or schedules PUCCH resources for the separate UCI associated with a CG-PUSCH.

At operation 714, UE 704 performs the partial uplink simultaneous transmission across multiple panels according to the uplink skipping information. For example, at operation 714, UE 704 transmits PUSCH 1 and PUSCH 2 using a subset of the resources allocated at operation 710. In some aspects, the UE 704 skips all of the PUSCH 1 and/or the PUSCH 2.

In some aspects, the UE 704 transmits the common UCI at operation 712 on a PUCCH (not shown). In some aspects, although shown as separate operations 712 and 714 in FIG. 7, the UE 704 transmits the common UCI at operation 712 by piggybacking (transmitting the UCI on) one of the PUSCHs as part of the partial uplink simultaneous transmission across multiple panels in operation 714. In some aspects, a repetition of the UCI is transmitted on the other PUSCH.

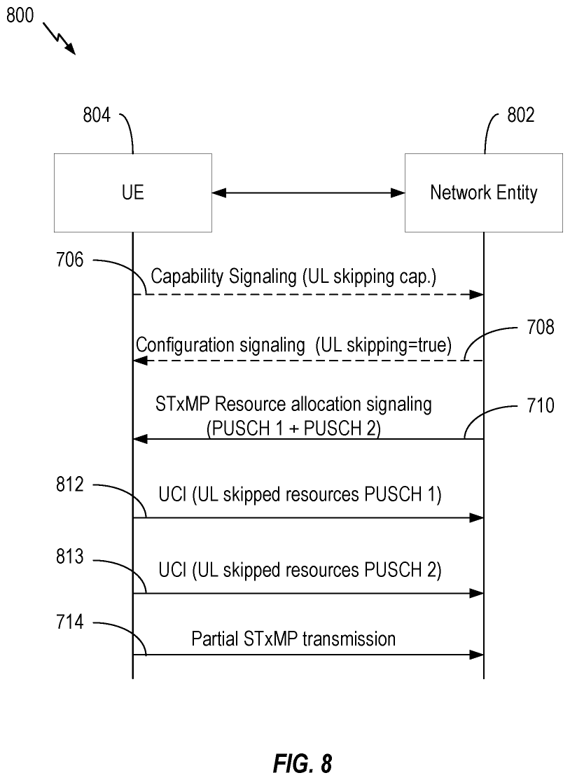

FIG. 8 depicts a process flow 800 for communications in a network between a UE 804 and a network entity 802 using separate UCI indicating partial uplink transmission for uplink simultaneous transmission across multiple panels. As shown in FIG. 8, the UE 804 and network entity 802 may perform the operations 706, 708, 710, and 714 as in the process flow 700 for the UE 704 and network entity 702 described above. At operation 812 and operation 813, the UE 804 transmits a separate dedicated UCI for the PUSCH 1 and the PUSCH 2, respectively, to network entity 802. For example, the UE 804 transmits a UCI at operation 812 to the network entity 802 indicating the uplink skipped resources for the PUSCH 1 and the UE 804 transmits a UCI at operation 813 to the network entity 802 indicating the uplink skipped resources for the PUSCH 2.

In some aspects, the separate UCI, transmitted at 812 and 813, are associated with different CORESET pool index values.

In some aspects, the UE 804 transmits the separate UCI at operation 812 and 813 on separate PUCCHs (not shown). In some aspects, although shown as separate operations 812, 813, and 714 in FIG. 8, the UE 804 transmits the one or both of the separate UCI at operation 812 and/or operation 813 by piggybacking (transmitting the UCI on) one of the PUSCHs as part of the partial uplink simultaneous transmission across multiple panels in operation 714. In some aspects, the separate UCI for the PUSCH 1 is piggybacked on the PUSCH 1 and the separate UCI for the PUSCH 2 is piggybacked on the PUSCH 2.

In some examples, a PUCCH is transmitted on a primary cell (e.g., secondary group primary cell or primary 5G cell referred to as SpCell, which may include a primary cell (PCell) and a primary second cell group (SCG) cell (PSCell)). In some examples, the PUSCH is transmitted on a secondary cell (SCell). In some aspects, the UCI transmitted at 712, 812, and/or 813 indicates a target component carrier (CC) associated with the uplink skipping information in the UCI.

In some aspects, for the separate UCI, the UCI at operation 812 indicates UL skipping for one or more CCs that are configured with a first CORSET pool index value (e.g., coresetPoolIndex=0) and the UCI at operation 813 indicates UL skipping for one or more CCs that are configured with a second CORSET pool index value (e.g., coresetPoolIndex=1).

In some aspects, the resource allocation signaling at operation 710 includes a dynamic grant DCI that activates or schedules PUCCH resources for the separate UCI used to indicate the uplink skipping information. In some aspects, the resource allocation signaling at operation 710 includes a configured grant and a DCI that activates the configured grant. In some examples, the activation DCI activates or schedules the PUCCH resources for the separate UCI used to indicate the uplink skipping information. In some aspects, the common UCI includes an indication of an offset, k, from the PUSCH at which the PUCCH carrying the UCI may be transmitted. In some examples, a dynamic grant DCI activates or schedules PUCCH resource for the separate UCI associated with a DG-PUSCH and an activation DCI activates or schedules PUCCH resources for the separate UCI associated with a CG-PUSCH.

In some aspects, when the UCI is piggybacked on a PUSCH, the UE performs rate matching and/or puncturing the resources (e.g., RBs) used for the UCI on at least one of the PUSCHs of the uplink simultaneous transmission across multiple panels in operation 714.

In some aspects, the network entity configures the UE for either a common UCI mode or a separate UCI mode. For example, the network entity may configure the common UCI or separate UCI based on the resource overlap between the PUSCH 1 and PUSCH 2.

In some aspects, the control signaling indicates the uplink skipping using one or two bits per resource set. For example, the allocated resources may be grouped into subsets of resources (e.g., RBs, symbols, or a combination thereof). For uplink simultaneous transmission across multiple panels, a given resource set may be utilized for transmission of both PUSCHs (e.g., utilized by both panels/TRPs, associated with both CORESET pool index values); utilized for transmission of PUSCH 1 (e.g., utilized by a single panel/TRP associated with a single CORESET pool index value); utilized for transmission of PUSCH 2 only (e.g., utilized by the other panel/TRP associated with another CORESET pool index value); or not utilized for transmission of either PUSCH 1 nor PUSCH 2. In some aspects, the UCI bits indicate a resource set is skipped for PUSCH 1 only, skipped for PUSCH 2 only, or skipped for both PUSCH 1 and PUSCH 2.

The resources that are skipped for a first PUSCH are a subset of resources in a second PUSCH. In some aspects, the UE may report skipped resources for the first PUSCH and then report the skipped resources for the second PUSCH as a delta difference with respect to the skipped resources of the first PUSCH. In the case of separate UCI, a first UCI may indicate the common skipped resources and the second UCI may indicate the delta different skipped resources. In the case of a common UCI, the common UCI may indicate common skipped resources and the delta difference resources. For example, a first stage of the UCI may indicate first skipping resources and the second stage of the UCI may indicate the delta difference resources. In illustrative example, a transmission parameter value X1 (e.g., MCS, number RBs, etc.) is used for PUSCH 1 and a different transmission parameter value X2 is used for PUSCH 2, then the first stage UCI may indicate X and second stage UCI may indicate a quantized version of X1-X2.

In some aspects, a configured grant included in the resource allocation at operation 710 may be adapted. The configured grant configures a first set of one or more transmission parameters for uplink simultaneous transmission across multiple panels. In some aspects, another configured grant or a dynamic grant can be used to adapt the first set of one or more transmission parameters. In an illustrative example, the configured grant may configure a first MCS and, based on a dynamic grant, the first MCS can be changed by a delta amount to a second MCS.

### Example Operations of a User Equipment

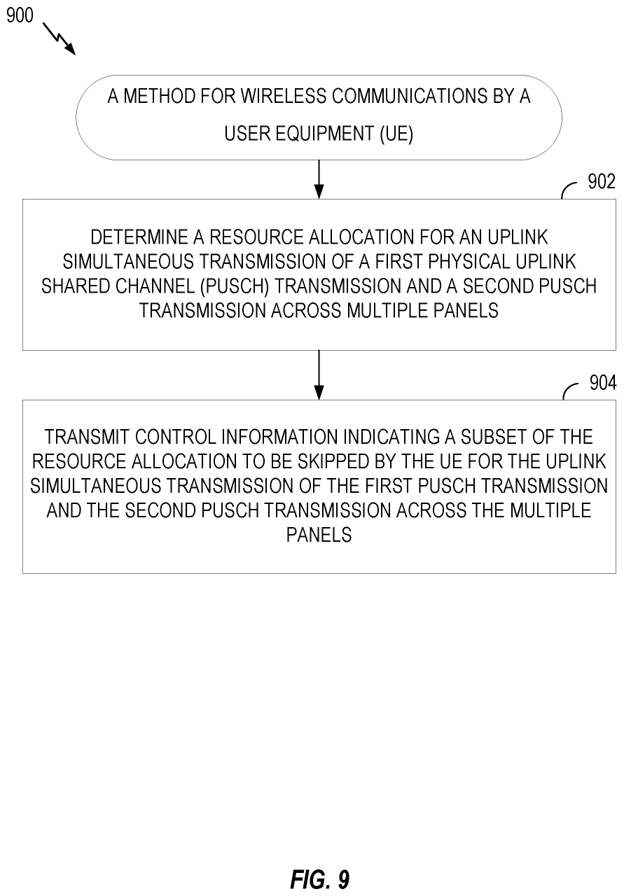

FIG. 9 shows a method 900 for wireless communications by a UE, such as UE 104 of FIGS. 1 and 3.

Method 900 begins at 902 with determining a resource allocation for an uplink simultaneous transmission of a first PUSCH transmission and a second PUSCH transmission across multiple panels.

In one aspect, the first PUSCH transmission and the second PUSCH transmission overlap at least partially in time. In one aspect, the first PUSCH transmission and the second PUSCH transmission are non-overlapping in frequency. In one aspect, the first PUSCH transmission and the second PUSCH transmission are partially overlapping in frequency. In one aspect, the first PUSCH transmission and the second PUSCH transmission are fully overlapping in frequency.

In one aspect, the first PUSCH transmission is associated with one or more of a first CORESET pool index value, a first SRS resource set, a first beam, a first TCI state, a first one or more power control parameters, or a first precoder, and wherein the second PUSCH transmission is associated with one or more of a second CORESET pool index value, a second SRS resource set, a second beam, a second TCI state, a second one or more power control parameters, or a second precoder.

In one aspect, determining the resource allocation for the uplink simultaneous transmission of the first PUSCH transmission and the second PUSCH transmission across the multiple panels, at step 902, includes receiving a dynamic grant for the first PUSCH transmission and a configured grant for the second PUSCH transmission; receiving a first dynamic grant for the first PUSCH transmission and a second dynamic grant for the second PUSCH transmission; or receiving a first configured grant for the first PUSCH transmission and a second configured grant for the second PUSCH transmission.

In one aspect, the resource allocation comprises one or more of time resources, frequency resources, PUSCH occasions, MCS, or a combination thereof for the uplink simultaneous transmission of the first PUSCH transmission and the second PUSCH transmission across the multiple panels.

In one aspect, determining the resource allocation for the uplink simultaneous transmission of the first PUSCH transmission and the second PUSCH transmission across the multiple panels, at step 902, includes receiving a configured grant indicating a first resource allocation for the uplink simultaneous transmission of the first PUSCH transmission and the second PUSCH transmission across the multiple panels; receiving a dynamic grant adapting the first resource allocation; and determining a second resource allocation for the uplink simultaneous transmission of the first PUSCH transmission and the second PUSCH transmission across the multiple panels based on the dynamic grant.

Method 900 then proceeds to step 904 with transmitting control information indicating a subset of the resource allocation to be skipped by the UE for the uplink simultaneous transmission of the first PUSCH transmission and the second PUSCH transmission across the multiple panels.

In one aspect, the subset of the resource allocation to be skipped by the UE for the uplink simultaneous transmission of the first PUSCH transmission and the second PUSCH transmission across the multiple panels comprises PUSCH occasions configured by a same configured grant or by different configuration grants.

In one aspect, the control information implicitly indicates the subset of the resource allocation to be skipped by the UE for the uplink simultaneous transmission of the first PUSCH transmission and the second PUSCH transmission across the multiple panels via an indication of a subset of the resource allocation that will be used by the UE for the uplink simultaneous transmission across the multiple panels.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting the control information indicating the subset of the resource allocation to be skipped by the UE for the uplink simultaneous transmission of the first PUSCH transmission and the second PUSCH transmission across the multiple panels in a CG UCI. In one aspect, the CG UCI is piggybacked on the first PUSCH, the second PUSCH, or a combination thereof.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting the control information indicating the subset of the resource allocation to be skipped by the UE for the uplink simultaneous transmission of the first PUSCH transmission and the second PUSCH transmission across the multiple panels in a dynamic UCI dedicated for indicating the uplink simultaneous transmission of the first PUSCH transmission and the second PUSCH transmission across the multiple panels. In one aspect, the dynamic UCI is transmitted on one or more PUCCHs.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting the control information indicating the subset of the resource allocation to be skipped by the UE for the uplink simultaneous transmission of the first PUSCH transmission and the second PUSCH transmission across the multiple panels in a MAC CE.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting a common UCI indicating the subset of the resource allocation to be skipped by the UE for the first PUSCH transmission and the second PUSCH transmission of the uplink simultaneous transmission across the multiple panels.

In one aspect, transmitting the common UCI indicating the subset of the resource allocation to be skipped by the UE for the first PUSCH transmission and the second PUSCH transmission includes piggybacking the common UCI indicating the subset of the resource allocation to be skipped by the UE for the first PUSCH transmission and the second PUSCH transmission on the first PUSCH or the second PUSCH.

In one aspect, method 900 further includes piggybacking a repetition of the common UCI on the other one of the first PUSCH or the second PUSCH.

In one aspect, transmitting the common UCI includes transmitting first information in the common UCI indicating a first portion of the subset of the resource allocation to be skipped for a first one or more portions of the first PUSCH transmission and the second PUSCH transmission that overlaps in time and frequency and transmitting second information in the common UCI indicating a second portion of the subset of the resource allocation to be skipped for a second one or more portions the first PUSCH transmission or the second PUSCH transmission that do not overlap in time and frequency.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting a first uplink UCI indicating a first portion of the subset of the resource allocation to be skipped by the UE for the first PUSCH transmission of the uplink simultaneous transmission across the multiple panels and transmitting a second UCI indicating a second portion of the subset of the resource allocation to be skipped by the UE for the second PUSCH transmission of the uplink simultaneous transmission across the multiple panels.

In one aspect, the first UCI is associated with a first CORESET pool index value, and wherein the second UCI associated with a second CORESET pool index value.

In one aspect, the first UCI includes a first indication of a first one or more CCs, configured with the first CORESET pool index value, to which the control information indicating the first portion of the subset of the resource allocation applies, and wherein the second UCI includes a second indication of a second one or CCs, configured with the second CORESET pool index value, to which the control information indicating the second portion of the subset of the resource allocation applies.

In one aspect, transmitting the first UCI indicating the first portion of the subset of the resource allocation to be skipped by the UE for the first PUSCH transmission includes piggybacking the first UCI indicating the first portion of the subset of the resource allocation to be skipped by the UE for the first PUSCH transmission on the first PUSCH and transmitting the second UCI indicating the second portion of the subset of the resource allocation to be skipped by the UE for the second PUSCH transmission includes piggybacking the second UCI indicating the second portion of the subset of the resource allocation to be skipped by the UE for the second PUSCH transmission on the second PUSCH.

In one aspect, transmitting the second UCI indicating the second portion of the subset of the resource allocation to be skipped by the UE for the second PUSCH transmission includes transmitting the second UCI only for portions of the second PUSCH transmission that are not overlapping in time and frequency with the first PUSCH transmission.

In one aspect, method 900 further includes receiving a DCI, where the DCI provides or activates the resource allocation for the uplink simultaneous transmission of the first PUSCH transmission and the second PUSCH transmission across the multiple panels, wherein the DCI further provides PUCCH resources for the control information indicating the subset of the resource allocation to be skipped by the UE for the uplink simultaneous transmission across the multiple panels.

In one aspect, method 900 further includes determining whether to transmit the control information indicating the subset of the resource allocation to be skipped by the UE for the uplink simultaneous transmission of the first PUSCH transmission and the second PUSCH transmission across the multiple panels using a common UCI or separate UCI transmissions based on whether at a least portion of the first PUSCH transmission and the second PUSCH transmission are overlapping in time and frequency.

In one aspect, the resource allocation includes a plurality of resource sets, each resource set including a group of resources of the resource allocation, and transmitting the control information indicating the subset of the resource allocation to be skipped by the UE for the uplink simultaneous transmission of the first PUSCH transmission and the second PUSCH transmission across the multiple panels comprises one bit per resource bit.

In one aspect, transmitting the control information indicating the subset of the resource allocation to be skipped by the UE for the uplink simultaneous transmission of the first PUSCH transmission and the second PUSCH transmission across the multiple panels at step 904 includes transmitting an indication that the first PUSCH transmission, the second PUSCH transmission, or both the first PUSCH transmission and the second PUSCH transmission is skipped.

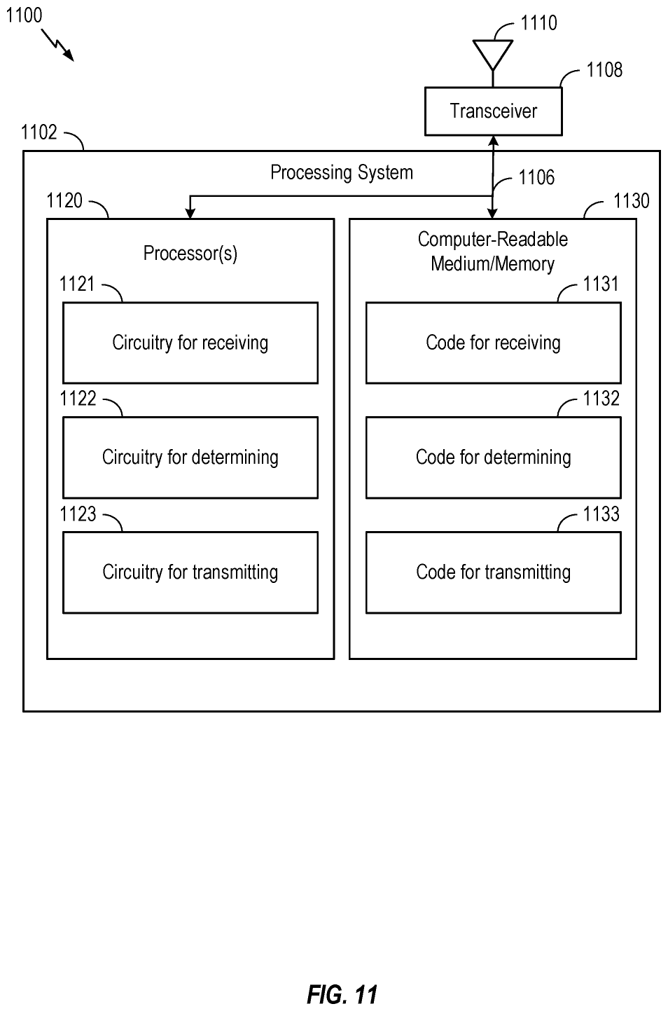

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

### Example Operations of a Network Entity

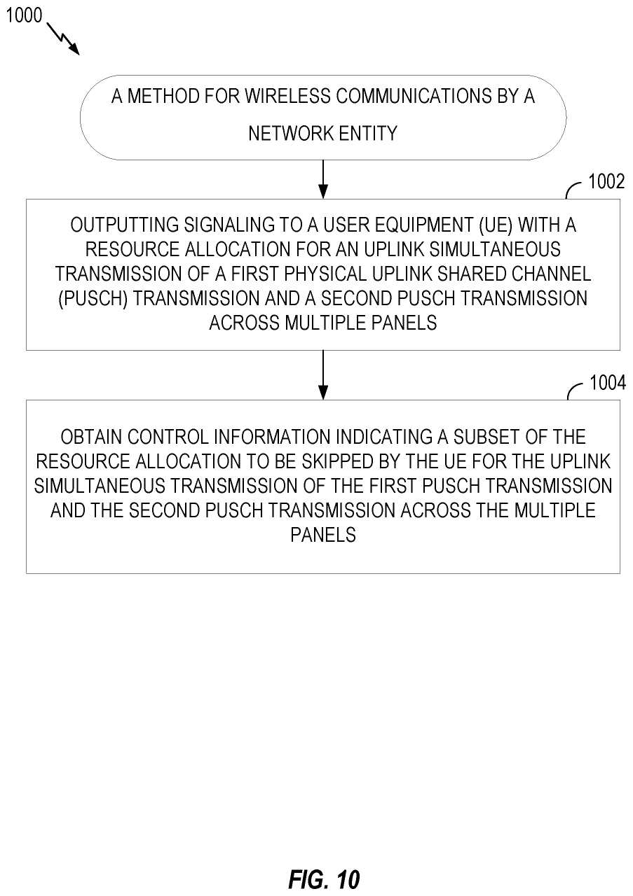

FIG. 10 shows a method 1000 for wireless communications by a network entity, such as BS 102 of FIGS. 1 and 3, or a disaggregated base station as discussed with respect to FIG. 2.

Method 1000 begins at 1002 with outputting signaling to a UE with a resource allocation for an uplink simultaneous transmission of a first PUSCH transmission and a second PUSCH transmission across multiple panels.

In one aspect, the first PUSCH transmission and the second PUSCH transmission overlap at least partially in time. In one aspect, the first PUSCH transmission and the second PUSCH transmission are non-overlapping in frequency. In one aspect, the first PUSCH transmission and the second PUSCH transmission are partially overlapping in frequency. In one aspect, the first PUSCH transmission and the second PUSCH transmission are fully overlapping in frequency.

In one aspect, the first PUSCH transmission is associated with one or more of a first CORESET pool index value, a first SRS resource set, a first beam, a first TCI state, a first one or more power control parameters, or a first precoder, and wherein the second PUSCH transmission is associated with one or more of a second CORESET pool index value, a second SRS resource set, a second beam, a second TCI state, a second one or more power control parameters, or a second precoder.

In one aspect, outputting the signaling with the resource allocation for the uplink simultaneous transmission of the first PUSCH transmission and the second PUSCH transmission across the multiple panels, at step 1002, includes outputting a dynamic grant for the first PUSCH transmission and a configured grant for the second PUSCH transmission; outputting a first dynamic grant for the first PUSCH transmission and a second dynamic grant for the second PUSCH transmission; or outputting a first configured grant for the first PUSCH transmission and a second configured grant for the second PUSCH transmission.

In one aspect, the resource allocation comprises one or more of time resources, frequency resources, PUSCH occasions, MCS, or a combination thereof for the uplink simultaneous transmission of the first PUSCH transmission and the second PUSCH transmission across the multiple panels.

In one aspect, outputting the signaling with the resource allocation for the uplink simultaneous transmission of the first PUSCH transmission and the second PUSCH transmission across the multiple panels, at step 1004, includes outputting a configured grant indicating a first resource allocation for the uplink simultaneous transmission of the first PUSCH transmission and the second PUSCH transmission across the multiple panels and outputting a dynamic grant adapting the first resource allocation, where the resource allocation for the uplink simultaneous transmission of the first PUSCH transmission and the second PUSCH transmission across the multiple panels is based on the dynamic grant.

Method 1000 then proceeds to step 1004 with obtaining control information indicating a subset of the resource allocation to be skipped by the UE for the uplink simultaneous transmission of the first PUSCH transmission and the second PUSCH transmission across the multiple panels.

In one aspect, the subset of the resource allocation to be skipped by the UE for the uplink simultaneous transmission of the first PUSCH transmission and the second PUSCH transmission across the multiple panels comprises PUSCH occasions configured by a same configured grant or by different configuration grants.

In one aspect, the control information implicitly indicates the subset of the resource allocation to be skipped by the UE for the uplink simultaneous transmission of the first PUSCH transmission and the second PUSCH transmission across the multiple panels via an indication of a subset of the resource allocation that will be used by the UE for the uplink simultaneous transmission across the multiple panels.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining the control information indicating the subset of the resource allocation to be skipped by the UE for the uplink simultaneous transmission of the first PUSCH transmission and the second PUSCH transmission across the multiple panels in a CG UCI. In one aspect, the CG UCI is piggybacked on the first PUSCH, the second PUSCH, or a combination thereof.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining the control information indicating the subset of the resource allocation to be skipped by the UE for the uplink simultaneous transmission of the first PUSCH transmission and the second PUSCH transmission across the multiple panels in a dynamic UCI dedicated for indicating the uplink simultaneous transmission of the first PUSCH transmission and the second PUSCH transmission across the multiple panels. In one aspect, the dynamic UCI is transmitted on one or more PUCCHs.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining the control information indicating the subset of the resource allocation to be skipped by the UE for the uplink simultaneous transmission of the first PUSCH transmission and the second PUSCH transmission across the multiple panels in a MAC CE.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining a common UCI indicating the subset of the resource allocation to be skipped by the UE for the first PUSCH transmission and the second PUSCH transmission of the uplink simultaneous transmission across the multiple panels.

In one aspect, obtaining the common UCI indicating the subset of the resource allocation to be skipped by the UE for the first PUSCH transmission and the second PUSCH transmission includes obtaining the common UCI indicating the subset of the resource allocation to be skipped by the UE for the first PUSCH transmission and the second PUSCH transmission piggybacked on the first PUSCH or the second PUSCH.

In one aspect, method 1000 further includes obtaining a repetition of the common UCI piggybacked on the other one of the first PUSCH or the second PUSCH.

In one aspect, obtaining the common UCI includes obtaining first information in the common UCI indicating a first portion of the subset of the resource allocation to be skipped for a first one or more portions of the first PUSCH transmission and the second PUSCH transmission that overlaps in time and frequency and transmitting second information in the common UCI indicating a second portion of the subset of the resource allocation to be skipped for a second one or more portions the first PUSCH transmission or the second PUSCH transmission that do not overlap in time and frequency.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining a first uplink UCI indicating a first portion of the subset of the resource allocation to be skipped by the UE for the first PUSCH transmission of the uplink simultaneous transmission across the multiple panels and obtaining a second UCI indicating a second portion of the subset of the resource allocation to be skipped by the UE for the second PUSCH transmission of the uplink simultaneous transmission across the multiple panels.

In one aspect, the first UCI is associated with a first CORESET pool index value, and wherein the second UCI associated with a second CORESET pool index value.

In one aspect, the first UCI includes a first indication of a first one or more CCs, configured with the first CORESET pool index value, to which the control information indicating the first portion of the subset of the resource allocation applies, and wherein the second UCI includes a second indication of a second one or CCs, configured with the second CORESET pool index value, to which the control information indicating the second portion of the subset of the resource allocation applies.

In one aspect, obtaining the first UCI indicating the first portion of the subset of the resource allocation to be skipped by the UE for the first PUSCH transmission includes obtaining the first UCI indicating the first portion of the subset of the resource allocation to be skipped by the UE for the first PUSCH transmission piggybacked on the first PUSCH and obtaining the second UCI indicating the second portion of the subset of the resource allocation to be skipped by the UE for the second PUSCH transmission includes obtaining the second UCI indicating the second portion of the subset of the resource allocation to be skipped by the UE for the second PUSCH transmission piggybacked on the second PUSCH.

In one aspect, obtaining the second UCI indicating the second portion of the subset of the resource allocation to be skipped by the UE for the second PUSCH transmission includes obtaining the second UCI only for portions of the second PUSCH transmission that are not overlapping in time and frequency with the first PUSCH transmission.

In one aspect, method 1000 further includes outputting a DCI, where the DCI provides or activates the resource allocation for the uplink simultaneous transmission of the first PUSCH transmission and the second PUSCH transmission across the multiple panels, wherein the DCI further provides PUCCH resources for the control information indicating the subset of the resource allocation to be skipped by the UE for the uplink simultaneous transmission across the multiple panels.

In one aspect, method 1000 further includes configuring the UE to transmit the control information indicating the subset of the resource allocation to be skipped by the UE for the uplink simultaneous transmission of the first PUSCH transmission and the second PUSCH transmission across the multiple panels using a common UCI or separate UCI transmissions based on whether at a least portion of the first PUSCH transmission and the second PUSCH transmission are overlapping in time and frequency.

In one aspect, the resource allocation includes a plurality of resource sets, each resource set including a group of resources of the resource allocation, and transmitting the control information indicating the subset of the resource allocation to be skipped by the UE for the uplink simultaneous transmission of the first PUSCH transmission and the second PUSCH transmission across the multiple panels comprises one bit per resource bit.

In one aspect, obtaining the control information indicating the subset of the resource allocation to be skipped by the UE for the uplink simultaneous transmission of the first PUSCH transmission and the second PUSCH transmission across the multiple panels at step 1004 includes obtaining an indication that the first PUSCH transmission, the second PUSCH transmission, or both the first PUSCH transmission and the second PUSCH transmission is skipped.

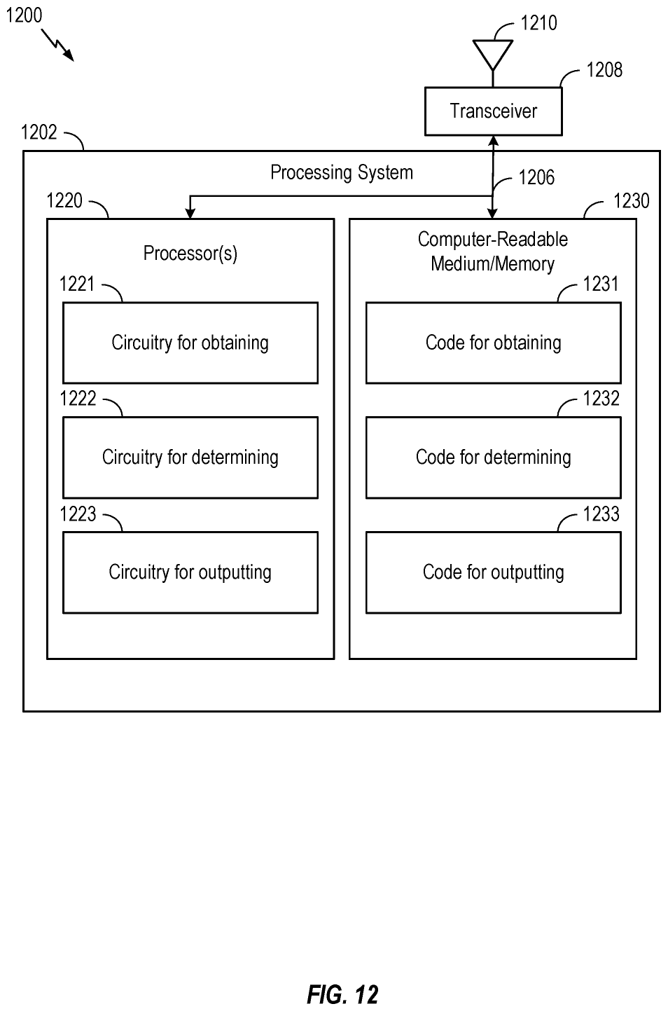

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 358, transmit processor 364, TX MIMO processor 366, and/or controller/processor 380, as described with respect to FIG. 3. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

In the depicted example, computer-readable medium/memory 1130 stores code (e.g., executable instructions) for transmitting 1131, code for determining 1132, and code for transmitting 1133. Processing of the code 1131-1133 may cause the communications device 1100 to perform the method 900 described with respect to FIG. 9, or any aspect related to it.

The one or more processors 1120 include circuitry configured to implement (e.g., execute) the code stored in the computer-readable medium/memory 1130, including circuitry for transmitting 1121, circuitry for determining 1122, and circuitry for receiving 1123. Processing with circuitry 1121-1123 may cause the communications device 1100 to perform the method 900 described with respect to FIG. 9, or any aspect related to it.

Various components of the communications device 1100 may provide means for performing the method 900 described with respect to FIG. 9, or any aspect related to it. For example, means for transmitting, sending or outputting for transmission may include the transceivers 354 and/or antenna(s) 352 of the UE 104 illustrated in FIG. 3 and/or transceiver 1108 and antenna 1110 of the communications device 1100 in FIG. 11. Means for receiving or obtaining may include the transceivers 354 and/or antenna(s) 352 of the UE 104 illustrated in FIG. 3 and/or transceiver 1108 and antenna 1110 of the communications device 1100 in FIG. 11.

FIG. 12 depicts aspects of an example communications device. In some aspects, communications device 1200 is a network entity, such as BS 102 of FIGS. 1 and 3, or a disaggregated base station as discussed with respect to FIG. 2.

The communications device 1200 includes a processing system 1202 coupled to a transceiver 1208 (e.g., a transmitter and/or a receiver) and/or a network interface 1212. The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 2. The processing system 1202 may be configured to perform processing functions for the communications device 1200, including processing signals received and/or to be transmitted by the communications device 1200.

The processing system 1202 includes one or more processors 1220. In various aspects, one or more processors 1220 may be representative of one or more of receive processor 338, transmit processor 320, TX MIMO processor 330, and/or controller/processor 340, as described with respect to FIG. 3. The one or more processors 1220 are coupled to a computer-readable medium/memory 1230 via a bus 1206. In certain aspects, the computer-readable medium/memory 1230 is configured to store instructions (e.g., computer-executable code) that when executed by the one or more processors 1220, cause the one or more processors 1220 to perform the method 1000 described with respect to FIG. 10, or any aspect related to it. Note that reference to a processor of communications device 1200 performing a function may include one or more processors of communications device 1200 performing that function.

In the depicted example, the computer-readable medium/memory 1230 stores code (e.g., executable instructions) for obtaining 1231, code for determining 1232, and code for outputting 1233. Processing of the code 1231-1233 may cause the communications device 1200 to perform the method 1000 described with respect to FIG. 10, or any aspect related to it.

The one or more processors 1220 include circuitry configured to implement (e.g., execute) the code stored in the computer-readable medium/memory 1230, including circuitry for obtaining 1221, circuitry for determining 1222, and circuitry for outputting 1223. Processing with circuitry 1221-1223 may cause the communications device 1200 to perform the method 1000 as described with respect to FIG. 10, or any aspect related to it.

Various components of the communications device 1200 may provide means for performing the method 1000 as described with respect to FIG. 10, or any aspect related to it. Means for transmitting, sending or outputting for transmission may include the transceivers 332 and/or antenna(s) 334 of the BS 102 illustrated in FIG. 3 and/or transceiver 1208 and antenna 1210 of the communications device 1200 in FIG. 12. Means for receiving or obtaining may include the transceivers 332 and/or antenna(s) 334 of the BS 102 illustrated in FIG. 3 and/or transceiver 1208 and antenna 1210 of the communications device 1200 in FIG. 12.

### Example Clauses

Implementation examples are described in the following numbered clauses:

Clause 1: A method for wireless communications by a user equipment (UE), comprising: determining a resource allocation for an uplink simultaneous transmission of a first physical uplink shared channel (PUSCH) transmission and a second PUSCH transmission across multiple panels; and transmitting control information indicating a subset of the resource allocation to be skipped by the UE for the uplink simultaneous transmission of the first PUSCH transmission and the second PUSCH transmission across the multiple panels.

Clause 2: The method of Clause 1, wherein the first PUSCH transmission and the second PUSCH transmission overlap at least partially in time.

Clause 3: The method of any combination of Clauses 1-2, wherein the first PUSCH transmission and the second PUSCH transmission are non-overlapping in frequency.

Clause 4: The method of any combination of Clauses 1-3, wherein the first PUSCH transmission and the second PUSCH transmission are partially overlapping in frequency.

Clause 5: The method of any combination of Clauses 1-4, wherein the first PUSCH transmission and the second PUSCH transmission are fully overlapping in frequency.

Clause 6: The method of any combination of Clauses 1-5, wherein the first PUSCH transmission is associated with one or more of a first control resource set (CORESET) pool index value, a first sounding reference signal (SRS) resource set, a first beam, a first transmission configuration indicator (TCI) state, a first one or more power control parameters, or a first precoder, and wherein the second PUSCH transmission is associated with one or more of a second CORESET pool index value, a second SRS resource set, a second beam, a second TCI state, a second one or more power control parameters, or a second precoder.

Clause 7: The method of any combination of Clauses 1-6, wherein determining the resource allocation for the uplink simultaneous transmission of the first PUSCH transmission and the second PUSCH transmission across the multiple panels comprises: receiving a dynamic grant for the first PUSCH transmission and a configured grant for the second PUSCH transmission; receiving a first dynamic grant for the first PUSCH transmission and a second dynamic grant for the second PUSCH transmission; or receiving a first configured grant for the first PUSCH transmission and a second configured grant for the second PUSCH transmission.

Clause 8: The method of any combination of Clauses 1-7, wherein the resource allocation comprises one or more of time resources, frequency resources, PUSCH occasions, modulation and coding scheme (MCS), or a combination thereof for the uplink simultaneous transmission of the first PUSCH transmission and the second PUSCH transmission across the multiple panels.

Clause 9: The method of Clause 8, wherein the subset of the resource allocation to be skipped by the UE for the uplink simultaneous transmission of the first PUSCH transmission and the second PUSCH transmission across the multiple panels comprises PUSCH occasions configured by a same configured grant or by different configuration grants.

Clause 10: The method of any combination of Clauses 1-9, wherein the control information implicitly indicates the subset of the resource allocation to be skipped by the UE for the uplink simultaneous transmission of the first PUSCH transmission and the second PUSCH transmission across the multiple panels via an indication of a subset of the resource allocation that will be used by the UE for the uplink simultaneous transmission across the multiple panels.

Clause 11: The method of any combination of Clauses 1-10, wherein transmitting the control information indicating the subset of the resource allocation to be skipped by the UE for the uplink simultaneous transmission of the first PUSCH transmission and the second PUSCH transmission across the multiple panels comprises transmitting the control information indicating the subset of the resource allocation to be skipped by the UE for the uplink simultaneous transmission of the first PUSCH transmission and the second PUSCH transmission across the multiple panels in a configured grant (CG) uplink control information (UCI).

Clause 12: The method of Clause 11, wherein the CG UCI is piggybacked on the first PUSCH, the second PUSCH, or a combination thereof.

Clause 13: The method of any combination of Clauses 1-12, wherein transmitting the control information indicating the subset of the resource allocation to be skipped by the UE for the uplink simultaneous transmission of the first PUSCH transmission and the second PUSCH transmission across the multiple panels comprises transmitting the control information indicating the subset of the resource allocation to be skipped by the UE for the uplink simultaneous transmission of the first PUSCH transmission and the second PUSCH transmission across the multiple panels in a dynamic uplink control information (UCI) dedicated for indicating the uplink simultaneous transmission of the first PUSCH transmission and the second PUSCH transmission across the multiple panels.

Clause 14: The method of Clause 13, wherein the dynamic UCI is transmitted on one or more physical uplink control channels (PUCCHs).

Clause 15: The method of any combination of Clauses 1-14, wherein transmitting the control information indicating the subset of the resource allocation to be skipped by the UE for the uplink simultaneous transmission of the first PUSCH transmission and the second PUSCH transmission across the multiple panels comprises transmitting the control information indicating the subset of the resource allocation to be skipped by the UE for the uplink simultaneous transmission of the first PUSCH transmission and the second PUSCH transmission across the multiple panels in a medium access control control element (MAC CE).

Clause 16: The method of any combination of Clauses 1-15, wherein transmitting the control information indicating the subset of the resource allocation to be skipped by the UE for the uplink simultaneous transmission of the first PUSCH transmission and the second PUSCH transmission across the multiple panels comprises transmitting a common uplink control information (UCI) indicating the subset of the resource allocation to be skipped by the UE for the first PUSCH transmission and the second PUSCH transmission of the uplink simultaneous transmission across the multiple panels.

Clause 17: The method of Clause 16, wherein transmitting the common UCI indicating the subset of the resource allocation to be skipped by the UE for the first PUSCH transmission and the second PUSCH transmission comprises piggybacking the common UCI indicating the subset of the resource allocation to be skipped by the UE for the first PUSCH transmission and the second PUSCH transmission on the first PUSCH or the second PUSCH.

Clause 18: The method of Clause 17, further comprising piggybacking a repetition of the common UCI on the other one of the first PUSCH or the second PUSCH.

Clause 19: The method of any combination of Clauses 16-18, wherein transmitting the common UCI comprises: transmitting first information in the common UCI indicating a first portion of the subset of the resource allocation to be skipped for a first one or more portions of the first PUSCH transmission and the second PUSCH transmission that overlaps in time and frequency; and transmitting second information in the common UCI indicating a second portion of the subset of the resource allocation to be skipped for a second one or more portions the first PUSCH transmission or the second PUSCH transmission that do not overlap in time and frequency.

Clause 20: The method of any combination of Clauses 1-19, wherein transmitting the control information indicating the subset of the resource allocation to be skipped by the UE for the uplink simultaneous transmission across the multiple panels comprises: transmitting a first uplink control information (UCI) indicating a first portion of the subset of the resource allocation to be skipped by the UE for the first PUSCH transmission of the uplink simultaneous transmission across the multiple panels; and transmitting a second UCI indicating a second portion of the subset of the resource allocation to be skipped by the UE for the second PUSCH transmission of the uplink simultaneous transmission across the multiple panels.

Clause 21: The method of Clause 20, wherein the first UCI is associated with a first control resource set (CORESET) pool index value, and wherein the second UCI associated with a second CORESET pool index value.

Clause 22: The method of Clause 21, wherein the first UCI includes a first indication of a first one or more component carriers (CCs), configured with the first CORESET pool index value, to which the control information indicating the first portion of the subset of the resource allocation applies, and wherein the second UCI includes a second indication of a second one or CCs, configured with the second CORESET pool index value, to which the control information indicating the second portion of the subset of the resource allocation applies.

Clause 23: The method of any combination of Clauses 20-22, wherein: transmitting the first UCI indicating the first portion of the subset of the resource allocation to be skipped by the UE for the first PUSCH transmission comprises piggybacking the first UCI indicating the first portion of the subset of the resource allocation to be skipped by the UE for the first PUSCH transmission on the first PUSCH; and transmitting the second UCI indicating the second portion of the subset of the resource allocation to be skipped by the UE for the second PUSCH transmission comprises piggybacking the second UCI indicating the second portion of the subset of the resource allocation to be skipped by the UE for the second PUSCH transmission on the second PUSCH.

Clause 24: The method of any combination of Clauses 20-23, wherein transmitting the second UCI indicating the second portion of the subset of the resource allocation to be skipped by the UE for the second PUSCH transmission comprises transmitting the second UCI only for portions of the second PUSCH transmission that are not overlapping in time and frequency with the first PUSCH transmission.

Clause 25: The method of any combination of Clauses 1-24, further comprising receiving a downlink control information (DCI), wherein the DCI provides or activates the resource allocation for the uplink simultaneous transmission of the first PUSCH transmission and the second PUSCH transmission across the multiple panels, wherein the DCI further provides physical uplink control channel (PUCCH) resources for the control information indicating the subset of the resource allocation to be skipped by the UE for the uplink simultaneous transmission across the multiple panels.

Clause 26: The method of any combination of Clauses 1-25, further comprising determining whether to transmit the control information indicating the subset of the resource allocation to be skipped by the UE for the uplink simultaneous transmission of the first PUSCH transmission and the second PUSCH transmission across the multiple panels using a common uplink control information (UCI) or separate UCI transmissions based on whether at a least portion of the first PUSCH transmission and the second PUSCH transmission are overlapping in time and frequency.

Clause 27: The method of any combination of Clauses 1-26, wherein the resource allocation comprises a plurality of resource sets, each resource set including a group of resources of the resource allocation, and wherein transmitting the control information indicating the subset of the resource allocation to be skipped by the UE for the uplink simultaneous transmission of the first PUSCH transmission and the second PUSCH transmission across the multiple panels comprises one bit per resource bit.

Clause 28: The method of any combination of Clauses 1-27, wherein transmitting the control information indicating the subset of the resource allocation to be skipped by the UE for the uplink simultaneous transmission of the first PUSCH transmission and the second PUSCH transmission across the multiple panels comprises transmitting an indication that the first PUSCH transmission, the second PUSCH transmission, or both the first PUSCH transmission and the second PUSCH transmission is skipped.

Clause 29: The method of any combination of Clauses 1-28, wherein determining the resource allocation comprises: receiving a configured grant indicating a first resource allocation for the uplink simultaneous transmission of the first PUSCH transmission and the second PUSCH transmission across the multiple panels; receiving a dynamic grant adapting the first resource allocation; and determining a second resource allocation for the uplink simultaneous transmission of the first PUSCH transmission and the second PUSCH transmission across the multiple panels based on the dynamic grant.

Clause 30: A method for wireless communications by a network entity, comprising: outputting signaling to a user equipment (UE) with a resource allocation for an uplink simultaneous transmission of a first physical uplink shared channel (PUSCH) transmission and a second PUSCH transmission across multiple panels; and obtaining control information indicating a subset of the resource allocation to be skipped by the UE for the uplink simultaneous transmission of the first PUSCH transmission and the second PUSCH transmission across the multiple panels.

Clause 31: The method of Clause 30, wherein the first PUSCH transmission and the second PUSCH transmission overlap at least partially in time.

Clause 32: The method of any combination of Clauses 30-31, wherein the first PUSCH transmission and the second PUSCH transmission are non-overlapping in frequency.

Clause 33: The method of any combination of Clauses 30-32, wherein the first PUSCH transmission and the second PUSCH transmission are partially overlapping in frequency.

Clause 34: The method of any combination of Clauses 30-33, wherein the first PUSCH transmission and the second PUSCH transmission are fully overlapping in frequency.

Clause 35: The method of any combination of Clauses 30-34, wherein the first PUSCH transmission is associated with one or more of a first control resource set (CORESET) pool index value, a first sounding reference signal (SRS) resource set, a first beam, a first transmission configuration indicator (TCI) state, a first one or more power control parameters, or a first precoder, and wherein the second PUSCH transmission is associated with one or more of a second CORESET pool index value, a second SRS resource set, a second beam, a second TCI state, a second one or more power control parameters, or a second precoder.

Clause 36: The method of any combination of Clauses 30-35, wherein outputting the signaling with the resource allocation for the uplink simultaneous transmission of the first PUSCH transmission and the second PUSCH transmission across the multiple panels comprises: outputting a dynamic grant for the first PUSCH transmission and a configured grant for the second PUSCH transmission; outputting a first dynamic grant for the first PUSCH transmission and a second dynamic grant for the second PUSCH transmission; or outputting a first configured grant for the first PUSCH transmission and a second configured grant for the second PUSCH transmission.

Clause 37: The method of any combination of Clauses 30-36, wherein the resource allocation comprises one or more of time resources, frequency resources, PUSCH occasions, modulation and coding scheme (MCS), or a combination thereof for the uplink simultaneous transmission of the first PUSCH transmission and the second PUSCH transmission across the multiple panels.

Clause 38: The method of Clause 37, wherein the subset of the resource allocation to be skipped by the UE for the uplink simultaneous transmission of the first PUSCH transmission and the second PUSCH transmission across the multiple panels comprises PUSCH occasions configured by a same configured grant or by different configuration grants.

Clause 39: The method of any combination of Clauses 30-38, wherein the control information implicitly indicates the subset of the resource allocation to be skipped by the UE for the uplink simultaneous transmission of the first PUSCH transmission and the second PUSCH transmission across the multiple panels via an indication of a subset of the resource allocation that will be used by the UE for the uplink simultaneous transmission across the multiple panels.

Clause 40: The method of any combination of Clauses 30-39, wherein obtaining the control information indicating the subset of the resource allocation to be skipped by the UE for the uplink simultaneous transmission of the first PUSCH transmission and the second PUSCH transmission across the multiple panels comprises obtaining the control information indicating the subset of the resource allocation to be skipped by the UE for the uplink simultaneous transmission of the first PUSCH transmission and the second PUSCH transmission across the multiple panels in a configured grant (CG) uplink control information (UCI).

Clause 41: The method of Clause 40, wherein the CG UCI is piggybacked on the first PUSCH, the second PUSCH, or a combination thereof.

Clause 42: The method of any combination of Clauses 30-41, wherein obtaining the control information indicating the subset of the resource allocation to be skipped by the UE for the uplink simultaneous transmission of the first PUSCH transmission and the second PUSCH transmission across the multiple panels comprises obtaining the control information indicating the subset of the resource allocation to be skipped by the UE for the uplink simultaneous transmission of the first PUSCH transmission and the second PUSCH transmission across the multiple panels in a dynamic uplink control information (UCI) dedicated for indicating the uplink simultaneous transmission of the first PUSCH transmission and the second PUSCH transmission across the multiple panels.

Clause 43: The method of Clause 42, wherein the dynamic UCI is transmitted on one or more physical uplink control channels (PUCCHs).

Clause 44: The method of any combination of Clauses 30-43, wherein obtaining the control information indicating the subset of the resource allocation to be skipped by the UE for the uplink simultaneous transmission of the first PUSCH transmission and the second PUSCH transmission across the multiple panels comprises obtaining the control information indicating the subset of the resource allocation to be skipped by the UE for the uplink simultaneous transmission of the first PUSCH transmission and the second PUSCH transmission across the multiple panels in a medium access control control element (MAC CE).

Clause 45: The method of any combination of Clauses 30-44, wherein obtaining the control information indicating the subset of the resource allocation to be skipped by the UE for the uplink simultaneous transmission of the first PUSCH transmission and the second PUSCH transmission across the multiple panels comprises obtaining a common uplink control information (UCI) indicating the subset of the resource allocation to be skipped by the UE for the first PUSCH transmission and the second PUSCH transmission of the uplink simultaneous transmission across the multiple panels.

Clause 46: The method of Clause 45, wherein obtaining the common UCI indicating the subset of the resource allocation to be skipped by the UE for the first PUSCH transmission and the second PUSCH transmission comprises obtaining the common UCI indicating the subset of the resource allocation to be skipped by the UE for the first PUSCH transmission and the second PUSCH transmission piggybacked on the first PUSCH or the second PUSCH.

Clause 47: The method of Clause 46, further comprising obtaining a repetition of the common UCI piggybacked on the other one of the first PUSCH or the second PUSCH.

Clause 48: The method of any combination of Clauses 45-47, wherein obtaining the common UCI comprises: obtaining first information in the common UCI indicating a first portion of the subset of the resource allocation to be skipped for a first one or more portions of the first PUSCH transmission and the second PUSCH transmission that overlaps in time and frequency; and obtaining second information in the common UCI indicating a second portion of the subset of the resource allocation to be skipped for a second one or more portions the first PUSCH transmission or the second PUSCH transmission that do not overlap in time and frequency.

Clause 49: The method of any combination of Clauses 30-48, wherein obtaining the control information indicating the subset of the resource allocation to be skipped by the UE for the uplink simultaneous transmission across the multiple panels comprises: obtaining a first uplink control information (UCI) indicating a first portion of the subset of the resource allocation to be skipped by the UE for the first PUSCH transmission of the uplink simultaneous transmission across the multiple panels; and obtaining a second UCI indicating a second portion of the subset of the resource allocation to be skipped by the UE for the second PUSCH transmission of the uplink simultaneous transmission across the multiple panels.

Clause 50: The method of Clause 49, wherein the first UCI is associated with a first control resource set (CORESET) pool index value, and wherein the second UCI associated with a second CORESET pool index value.

Clause 51: The method of Clause 50, wherein the first UCI includes a first indication of a first one or more component carriers (CCs), configured with the first CORESET pool index value, to which the control information indicating the first portion of the subset of the resource allocation applies, and wherein the second UCI includes a second indication of a second one or CCs, configured with the second CORESET pool index value, to which the control information indicating the second portion of the subset of the resource allocation applies.

Clause 52: The method of any combination of Clauses 49-51, wherein: obtaining the first UCI indicating the first portion of the subset of the resource allocation to be skipped by the UE for the first PUSCH transmission comprises obtaining the first UCI indicating the first portion of the subset of the resource allocation to be skipped by the UE for the first PUSCH transmission piggybacked on the first PUSCH; and obtaining the second UCI indicating the second portion of the subset of the resource allocation to be skipped by the UE for the second PUSCH transmission comprises obtaining the second UCI indicating the second portion of the subset of the resource allocation to be skipped by the UE for the second PUSCH transmission piggybacked on the second PUSCH.

Clause 55: The method of any combination of Clauses 49-54, wherein obtaining the second UCI indicating the second portion of the subset of the resource allocation to be skipped by the UE for the second PUSCH transmission comprises obtaining the second UCI only for portions of the second PUSCH transmission that are not overlapping in time and frequency with the first PUSCH transmission.

Clause 56: The method of any combination of Clauses 30-55, further comprising outputting a downlink control information (DCI), wherein the DCI provides or activates the resource allocation for the uplink simultaneous transmission of the first PUSCH transmission and the second PUSCH transmission across the multiple panels, wherein the DCI further provides physical uplink control channel (PUCCH) resources for the control information indicating the subset of the resource allocation to be skipped by the UE for the uplink simultaneous transmission across the multiple panels.

Clause 57: The method of any combination of Clauses 30-56, further comprising configuring the UE to transmit the control information indicating the subset of the resource allocation to be skipped by the UE for the uplink simultaneous transmission of the first PUSCH transmission and the second PUSCH transmission across the multiple panels using a common uplink control information (UCI) or separate UCI transmissions based on whether at a least portion of the first PUSCH transmission and the second PUSCH transmission are overlapping in time and frequency.

Clause 58: The method of any combination of Clauses 30-57, wherein the resource allocation comprises a plurality of resource sets, each resource set including a group of resources of the resource allocation, and wherein the control information indicating the subset of the resource allocation to be skipped by the UE for the uplink simultaneous transmission of the first PUSCH transmission and the second PUSCH transmission across the multiple panels comprises one bit per resource bit.

Clause 59: The method of any combination of Clauses 30-58, wherein obtaining the control information indicating the subset of the resource allocation to be skipped by the UE for the uplink simultaneous transmission of the first PUSCH transmission and the second PUSCH transmission across the multiple panels comprises obtaining an indication that the first PUSCH transmission, the second PUSCH transmission, or both the first PUSCH transmission and the second PUSCH transmission is skipped.

Clause 60: The method of any combination of Clauses 30-59, wherein outputting the signaling with the resource allocation comprises: outputting a configured grant indicating a first resource allocation for the uplink simultaneous transmission of the first PUSCH transmission and the second PUSCH transmission across the multiple panels; and outputting a dynamic grant adapting the first resource allocation, wherein the resource allocation for the uplink simultaneous transmission of the first PUSCH transmission and the second PUSCH transmission across the multiple panels is based on the dynamic grant.

Clause 61: An apparatus, comprising: a memory comprising executable instructions; and a processor configured to execute the executable instructions and cause the apparatus to perform a method in accordance with any one of Clauses 1-60.

Clause 62: An apparatus, comprising means for performing a method in accordance with any one of Clauses 1-60.

Clause 63: A non-transitory computer-readable medium comprising executable instructions that, when executed by a processor of an apparatus, cause the apparatus to perform a method in accordance with any one of Clauses 1-60.

Clause 64: A computer program product embodied on a computer-readable storage medium comprising code for performing a method in accordance with any one of Clauses 1-60.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
at least one processor; and
a memory comprising computer executable code that, when executed by the at least one processor, causes the UE to:
determine a resource allocation for an uplink simultaneous transmission of a first physical uplink shared channel (PUSCH) transmission and a second PUSCH transmission across multiple panels; and
transmit control information indicating a subset of the resource allocation to be skipped by the UE for the uplink simultaneous transmission of the first PUSCH transmission and the second PUSCH transmission across the multiple panels.

2. The user equipment of claim 1, wherein the first PUSCH transmission and the second PUSCH transmission are non-overlapping in frequency.

3. The user equipment of claim 1, wherein the first PUSCH transmission and the second PUSCH transmission are partially overlapping in frequency.

4. The user equipment of claim 1, wherein the first PUSCH transmission and the second PUSCH transmission are fully overlapping in frequency.

5. The user equipment of claim 1, wherein the first PUSCH transmission is associated with one or more of a first control resource set (CORESET) pool index value, a first sounding reference signal (SRS) resource set, a first beam, a first transmission configuration indicator (TCI) state, a first one or more power control parameters, or a first precoder, and wherein the second PUSCH transmission is associated with one or more of a second CORESET pool index value, a second SRS resource set, a second beam, a second TCI state, a second one or more power control parameters, or a second precoder.

6. The user equipment of claim 1, wherein the computer executable code that, when executed by the at least one processor, causes the UE to determine the resource allocation for the uplink simultaneous transmission of the first PUSCH transmission and the second PUSCH transmission across the multiple panels comprises computer executable code that, when executed by the at least one processor, causes the UE to:
receive a dynamic grant for the first PUSCH transmission and a configured grant for the second PUSCH transmission;
receive a first dynamic grant for the first PUSCH transmission and a second dynamic grant for the second PUSCH transmission; or
receive a first configured grant for the first PUSCH transmission and a second configured grant for the second PUSCH transmission.

7. The user equipment of claim 1, wherein the resource allocation comprises one or more of time resources, frequency resources, PUSCH occasions, modulation and coding scheme (MCS), or a combination thereof for the uplink simultaneous transmission of the first PUSCH transmission and the second PUSCH transmission across the multiple panels.

8. The user equipment of claim 7, wherein the subset of the resource allocation to be skipped by the UE for the uplink simultaneous transmission of the first PUSCH transmission and the second PUSCH transmission across the multiple panels comprises PUSCH occasions configured by a same configured grant or by different configuration grants.

9. The user equipment of claim 1, wherein the control information implicitly indicates the subset of the resource allocation to be skipped by the UE for the uplink simultaneous transmission of the first PUSCH transmission and the second PUSCH transmission across the multiple panels via an indication of a subset of the resource allocation that will be used by the UE for the uplink simultaneous transmission across the multiple panels.

10. The user equipment of claim 1, wherein the computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels comprises computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels in a configured grant (CG) uplink control information (UCI).

11. The user equipment of claim 10, wherein the CG UCI is piggybacked on the first PUSCH, the second PUSCH, or a combination thereof.

12. The user equipment of claim 1, wherein the computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels comprises computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels in a dynamic uplink control information (UCI) dedicated for indicating the uplink simultaneous transmission of the first PUSCH transmission and the second PUSCH transmission across the multiple panels.

13. The user equipment of claim 1, wherein the computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels comprises computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels in a medium access control control element (MAC CE).

14. The user equipment of claim 1, wherein the computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels comprises computer executable code that, when executed by the at least one processor, causes the UE to transmit a common uplink control information (UCI) indicating the subset of the resource allocation to be skipped by the UE for the first PUSCH transmission and the second PUSCH transmission of the uplink simultaneous transmission across the multiple panels.

15. The user equipment of claim 14, wherein the computer executable code that, when executed by the at least one processor, causes the UE to transmit the common UCI indicating the subset of the resource allocation to be skipped by the UE for the first PUSCH transmission and the second PUSCH transmission comprises computer executable code that, when executed by the at least one processor, causes the UE to piggyback the common UCI indicating the subset of the resource allocation to be skipped by the UE for the first PUSCH transmission and the second PUSCH transmission on the first PUSCH or the second PUSCH.

16. The user equipment of claim 15, wherein the computer executable code, when executed by the at least one processor, further causes the UE to piggyback a repetition of the common UCI on the other one of the first PUSCH or the second PUSCH.

17. The user equipment of claim 15, wherein the computer executable code that, when executed by the at least one processor, causes the UE to transmit the common UCI comprises computer executable code that, when executed by the at least one processor, causes the UE to:
transmit first information in the common UCI indicating a first portion of the subset of the resource allocation to be skipped for a first one or more portions of the first PUSCH transmission and the second PUSCH transmission that overlaps in time and frequency; and
transmit second information in the common UCI indicating a second portion of the subset of the resource allocation to be skipped for a second one or more portions the first PUSCH transmission or the second PUSCH transmission that do not overlap in time and frequency.

18. The user equipment of claim 1, wherein the computer executable code that, when executed by the at least one processor, causes the UE to transmit the control information indicating the subset of the resource allocation to be skipped by the UE for the uplink simultaneous transmission across the multiple panels comprises computer executable code that, when executed by the at least one processor, causes the UE to:
transmit a first uplink control information (UCI) indicating a first portion of the subset of the resource allocation to be skipped by the UE for the first PUSCH transmission of the uplink simultaneous transmission across the multiple panels; and
transmit a second UCI indicating a second portion of the subset of the resource allocation to be skipped by the UE for the second PUSCH transmission of the uplink simultaneous transmission across the multiple panels.

19. The user equipment of claim 18, wherein the first UCI is associated with a first control resource set (CORESET) pool index value, and wherein the second UCI associated with a second CORESET pool index value.

20. The user equipment of claim 19, wherein the first UCI includes a first indication of a first one or more component carriers (CCs), configured with the first CORESET pool index value, to which the control information indicating the first portion of the subset of the resource allocation applies, and wherein the second UCI includes a second indication of a second one or CCs, configured with the second CORESET pool index value, to which the control information indicating the second portion of the subset of the resource allocation applies.

21. The user equipment of claim 18, wherein:
the computer executable code that, when executed by the at least one processor, causes the UE to transmit the first UCI indicating the first portion of the subset of the resource allocation to be skipped by the UE for the first PUSCH transmission comprises computer executable code that, when executed by the at least one processor, causes the UE to piggyback the first UCI indicating the first portion of the subset of the resource allocation to be skipped by the UE for the first PUSCH transmission on the first PUSCH; and
the computer executable code that, when executed by the at least one processor, causes the UE to transmit the second UCI indicating the second portion of the subset of the resource allocation to be skipped by the UE for the second PUSCH transmission comprises computer executable code that, when executed by the at least one processor, causes the UE to piggyback the second UCI indicating the second portion of the subset of the resource allocation to be skipped by the UE for the second PUSCH transmission on the second PUSCH.

22. The user equipment of claim 18, wherein the computer executable code that, when executed by the at least one processor, causes the UE to transmit the second UCI indicating the second portion of the subset of the resource allocation to be skipped by the UE for the second PUSCH transmission comprises computer executable code that, when executed by the at least one processor, causes the UE to transmit the second UCI only for portions of the second PUSCH transmission that are not overlapping in time and frequency with the first PUSCH transmission.

23. The user equipment of claim 1, wherein the computer executable code, when executed by the at least one processor, further causes the UE to receive a downlink control information (DCI), wherein the DCI provides or activates the resource allocation for the uplink simultaneous transmission of the first PUSCH transmission and the second PUSCH transmission across the multiple panels, and wherein the DCI further provides physical uplink control channel (PUCCH) resources for the control information indicating the subset of the resource allocation to be skipped by the UE for the uplink simultaneous transmission across the multiple panels.

24. The user equipment of claim 1, wherein the computer executable code, when executed by the at least one processor, further causes the UE to determine whether to transmit the control information indicating the subset of the resource allocation to be skipped by the UE for the uplink simultaneous transmission of the first PUSCH transmission and the second PUSCH transmission across the multiple panels using a common uplink control information (UCI) or separate UCI transmissions based on whether at a least portion of the first PUSCH transmission and the second PUSCH transmission are overlapping in time and frequency.

25. The user equipment of claim 1, wherein the resource allocation comprises a plurality of resource sets, each resource set including a group of resources of the resource allocation, and wherein transmitting the control information indicating the subset of the resource allocation to be skipped by the UE for the uplink simultaneous transmission of the first PUSCH transmission and the second PUSCH transmission across the multiple panels comprises one bit per resource bit.

26. The user equipment of claim 1, wherein the computer executable code that, when executed by the at least one processor, causes the UE to transmit the control information indicating the subset of the resource allocation to be skipped by the UE for the uplink simultaneous transmission of the first PUSCH transmission and the second PUSCH transmission across the multiple panels comprises computer executable code that, when executed by the at least one processor, causes the UE to transmit an indication that the first PUSCH transmission, the second PUSCH transmission, or both the first PUSCH transmission and the second PUSCH transmission is skipped.

27. The user equipment of claim 1, wherein the computer executable code that, when executed by the at least one processor, causes the UE to determine the resource allocation comprises computer executable code that, when executed by the at least one processor, causes the UE to:
receive a configured grant indicating a first resource allocation for the uplink simultaneous transmission of the first PUSCH transmission and the second PUSCH transmission across the multiple panels;
receive a dynamic grant adapting the first resource allocation; and
determine a second resource allocation for the uplink simultaneous transmission of the first PUSCH transmission and the second PUSCH transmission across the multiple panels based on the dynamic grant.

28. A network entity, comprising:
at least one processor; and
a memory comprising computer executable code that, when executed by the at least one processor, causes the network entity to:
output signaling to a user equipment (UE) with a resource allocation for an uplink simultaneous transmission of a first physical uplink shared channel (PUSCH) transmission and a second PUSCH transmission across multiple panels; and
obtain control information indicating a subset of the resource allocation to be skipped by the UE for the uplink simultaneous transmission of the first PUSCH transmission and the second PUSCH transmission across the multiple panels.

29. A method for wireless communications by a user equipment (UE), comprising:
determining a resource allocation for an uplink simultaneous transmission of a first physical uplink shared channel (PUSCH) transmission and a second PUSCH transmission across multiple panels; and
transmitting control information indicating a subset of the resource allocation to be skipped by the UE for the uplink simultaneous transmission of the first PUSCH transmission and the second PUSCH transmission across the multiple panels.

30. A method for wireless communications by a network entity, comprising:
outputting signaling to a user equipment (UE) with a resource allocation for an uplink simultaneous transmission of a first physical uplink shared channel (PUSCH) transmission and a second PUSCH transmission across multiple panels; and
obtaining control information indicating a subset of the resource allocation to be skipped by the UE for the uplink simultaneous transmission of the first PUSCH transmission and the second PUSCH transmission across the multiple panels.
